(19) United States
(12) Patent Application Publication
(10) Pub. No.: US 2024/0340688 A1
(43) Pub. Date: Oct. 10, 2024

(54) METHOD AND APPARATUS FOR SUPPORTING MAXIMUM GROUP DATA RATE

(71) Applicant: SAMSUNG ELECTRONICS CO., LTD., Suwon-si (KR)

(72) Inventor: Sangjun MOON, Suwon-si (KR)

(21) Appl. No.: 18/627,395

(22) Filed: Apr. 4, 2024

(30) Foreign Application Priority Data
Apr. 6, 2023 (KR) 10-2023-0045154

(51) Int. Cl. H04W 28/02; H04W 48/18; H04W 76/10

(52) U.S. Cl. CPC H04W 28/0268; H04W 48/18; H04W 76/10

(57) ABSTRACT

The disclosure relates to a 5G or 6G communication system for supporting a high data transmission rate. An embodiment of the disclosure may disclose a method for supporting a maximum data rate for each group in a 5G system, and the method may include a method of comparing an MBR with a remaining group MBR in a case of a GBR or comparing a session-AMBR with a remaining group MBR in a case of a non-GBR and updating the remaining group MBR by subtracting the MBR or the session-AMBR from the remaining group MBR when the remaining group MBR is greater than the MBR or the session-AMBR.

### CROSS-REFERENCE TO RELATED APPLICATION

This application is based on and claims priority under 35 U.S.C. § 119 to Korean Patent Application No. 10-2023-0045154, filed on Apr. 6, 2023, in the Korean Intellectual Property Office, the disclosure of which is herein incorporated by reference in its entirety.

### BACKGROUND

### 1. Field

The disclosure relates to expanding a function of supporting group communication in a wireless communication network, specifically, in a 3rd generation partnership project (3GPP) 5th generation (5G) system (GS), and relates to a method of supporting provisioning and monitoring for traffic of each group by allocating a maximum transmission rate for each group.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In a conventional 5G system, there is a method for supporting a maximum data rate for each network slice but there is no method for supporting a maximum data rate for each group, thus making it impossible to support a maximum data rate per group for each UE belonging to a group even within the same slice.

The above information is presented as background information only to assist with an understanding of the disclosure. No determination has been made, and no assertion is made, as to whether any of the above might be applicable as prior art with regard to the disclosure.

### SUMMARY

An aspect of the disclosure is to support a method of configuring and managing a maximum data rate for each group.

According to an embodiment of the present disclosure, there is provided a method performed by a policy and control function (PCF) in a wireless communications system, comprising receiving, from a session management function (SMF), a session management (SM) policy association request message for establishing a packet data unit (PDU) session, wherein the SM policy association request message includes a data network name (DNN) and single network slice selection assistance information (S-NSSAI) for a user equipment (UE) group; transmitting, to a united data repository (UDR), a subscribe request message for a group maximum bit rate (MBR) for the UE group; receiving, from the UDR, a notification message including a remaining group MBR for the UE group; determining whether the remaining group MBR is higher than a MBR of the PDU session, in case that the PDU session is associated with a guaranteed bit rate (GBR); determining whether the remaining group MBR is higher than an authorized sessions aggregated maximum bit rate (AMBR) of the PDU session, in case that the PDU session is not associated with the GBR; performing an update for the remaining group MBR based on the determination; and transmitting, to the UDR, an update message including the updated remaining group MBR.

In an embodiment, wherein the performing the update for the remaining group MBR comprises one of: deducting a value of the MBR from the remaining group MBR in case that the remaining group MBR is higher than the MBR of the PDU session and the PDU sessions is associated with the GBR; or deducting a value of the AMBR from the remaining group MBR in case that the remaining group MBR is higher than the AMBR of the PDU session and the PDU session is not associated with the GBR.

In an embodiment, the method performed by the PCF further comprises transmitting, to the SMF, a SM policy association response message including the updated remaining group MBR, in case that the remaining group MBR is higher than the MBR or the AMBR of the PDU session.

In an embodiment, the method performed by the PCF further comprises transmitting, to the SMF, a SM policy association response message indicating a reject of a PDU session establishment, in case that the remaining group MBR is lower than the MBR or the AMBR of the PDU session.

In an embodiment, the remaining group MBR is separately configured for an uplink and a downlink.

According to an embodiment of the present disclosure, there is provided a method performed by a united data management (UDM) in a wireless communication system, comprising receiving, from an application function (AF), a parameter update request message including a group maximum bit rate (MBR) for a user equipment (UE) group; transmitting, to a united data repository (UDR), a request message for group data of the UE group; receiving, from the UDR, the group data of the UE group including an updated group MBR; and transmitting, to the AF, a parameter update response message including the updated group MBR.

In an embodiment, the method performed by the UDM further comprises configuring the group MBR before receiving the parameter update request message from the AF.

According to embodiments of the disclosure, it is possible to support a service considering a maximum transmission rate for each group in a 5G system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a maximum data rate for each group in a 5G system according to an embodiment of the present disclosure;

FIG. 2 illustrates an operation flow of a provisioning method for supporting a maximum data rate for each group according to an embodiment of the present disclosure;

FIG. 3 illustrates an operation flow of accepting a corresponding flow by performing control for each PDU session to support a maximum data rate for each group according to an embodiment of the present disclosure;

FIG. 4 illustrates an operation flow of rejecting a corresponding flow by performing control for each PDU session to support a maximum data rate for each group according to an embodiment of the present disclosure;

FIG. 5 illustrates a terminal according to an embodiment of the present disclosure; and

FIG. 6 illustrates a network entity according to an embodiment of the present disclosure.

### DETAILED DESCRIPTION

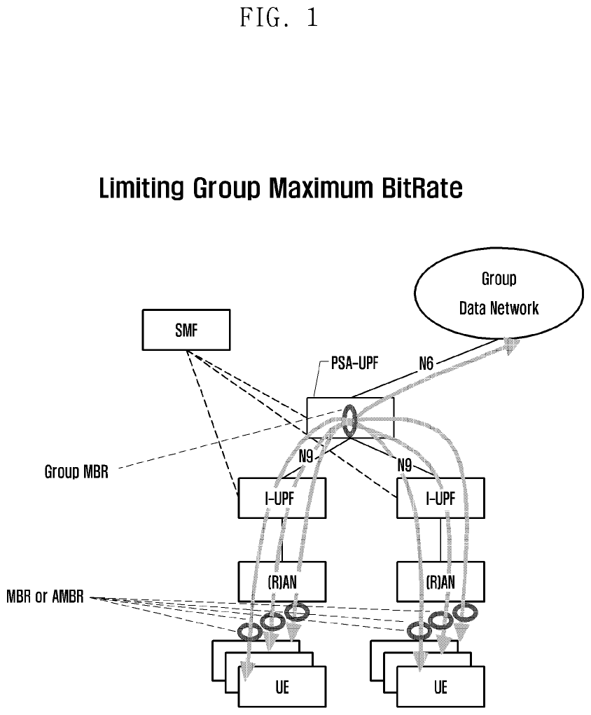

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operation principle of the disclosure will be described in detail with reference to the accompanying drawings. In the following description of the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description of the disclosure, terms and names defined in the 5GS and NR standards, which are the latest standards specified by the 3rd generation partnership project (3GPP) group among the existing communication standards, will be used for the sake of descriptive convenience. However, the disclosure is not limited by these terms and names, and may be applied in the same way to systems that conform other standards. In particular, the disclosure may be applied to 3GPP 5GS/NR (5th generation mobile communication standard).

FIG. 1 illustrates a maximum data rate for each group in a 5G system according to an embodiment of the present disclosure. Traffic of each UE corresponding to each member in a group supports a maximum data rate, and a maximum data rate of traffic of each group refers to the sum of maximum data rates for respective members. That is, a group maximum bitrate limits the sum of maximum data rates of separate flows of members in a group. Each flow may be classified as a guaranteed bitrate (GBR) or a non-GBR. A GBR flow needs to consider a maximum bit rate (MBR), and a non-GBR flow needs to consider an aggregated maximum bitrate (AMBR). That is, an MBR for each group needs to be less than or equal to the sum of the sum of maximum bitrates (MBRs) of guaranteed bitrate (GBR) flows in a group and the sum of aggregated maximum bitrate (AMBRs) of non-GBR flows in the group. Each flow may be divided into an uplink (UL) flow and a downlink (DL) flow, and a corresponding maximum data rate may also be divided into a UL date rate and a DL data rate. Therefore, the MBR for each group may be applied separately depending on a DL and a UL. Here, a session management function (SMF) to manage communication of each group may be in charge of controlling each flow.

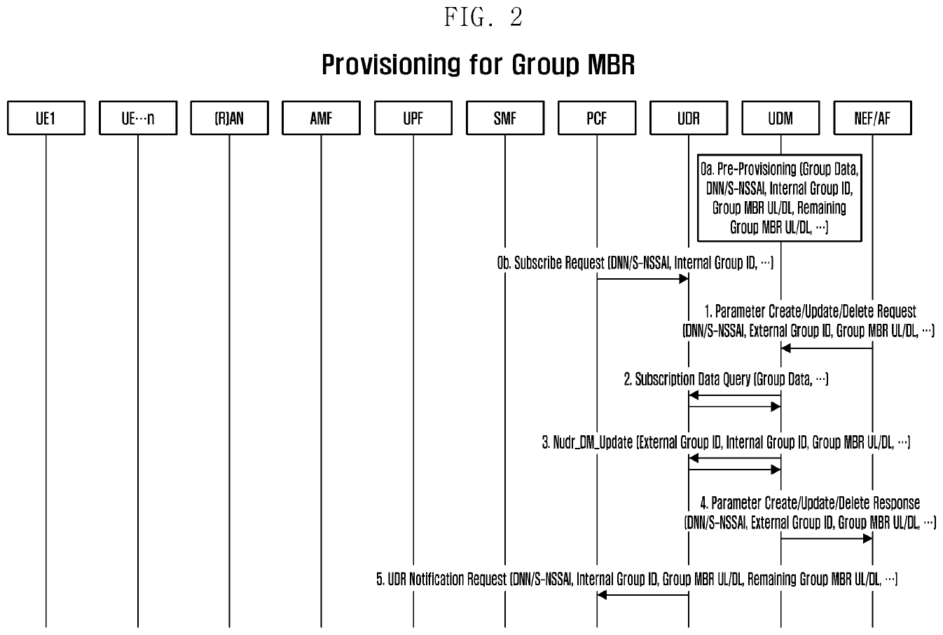

FIG. 2 illustrates an operation flow of a method of provisioning a group MBR to support a maximum data rate for each group according to an embodiment of the present disclosure.

A UDR may temporarily record and store a maximum data rate for each group to support the maximum data rate for each group, and a PCF may perform monitoring and control for each separate flow to support the maximum data rate for each group. Whenever allowing a new flow, the PCF may subtract an MBR of a GBR and an AMBR of a non-GRR, and record a remaining data rate for each group in the UDR.

When the remaining data rate is less than the MBR or AMBR, an additional measure may be conducted for a corresponding QoS flow as shown below:
(1) Not allowing the QoS flow;
(2) Reporting an additional data rate by reporting to a corresponding application function (AF);
(3) Reporting to a corresponding charging function (CHF) and applying a separate charging rule;
(4) Applying (1) and (2) at the same time: Not allowing the QoS flow and reporting the additional data rate by reporting to the application function (AF); and/or
(5) Applying (3) and (2) at the same time: Reporting to the corresponding charging function (CHF) and applying the separate charging rule, and reporting the additional data rate by reporting to the application function (AF).

The following method may be applied to identify traffic of each group:
(1) Using only a DNN and an S-NSSAI mapped to the group in combination;
(2) Using the DNN, the S-NSSAI, and an internal group ID mapped to the group in combination;
(3) Using only the internal group ID mapped to the group;
(4) Using only the internal group ID and the S-NSSAI mapped to the group in combination; and/or
(5) Using only the internal group ID and the DNN mapped to the group in combination.

In operation 0a, a group may be preconfigured. In detail, group data, a DNN/S-NSSAI, an internal group ID, a group MBR UL/DL, a remaining group MBR UL/DL, and the like may be preconfigured. The group data may include attribute information, such as the internal group ID, a member list, and a restricted area of each group.

In operation Ob, the PCF may transmit a subscribe request to the UDR to request the UDR to report any change in the conditions. The subscribe request may include the DNN/S-NSSAI, the internal group ID, and the like.

In operation 1, the AF may request application of a maximum data rate for each group by transmitting a parameter create/update/delete request for the group to a UDM via an NEF or directly. The parameter create/update/delete request may include the DNN/S-NSSAI, an external group ID, the group MBR UL/DL, and the like.

In operation 2, the UDM may check the group data through the UDR, and may subscribe to be notified of a change in the data of the group. The group data may include the attribute information, such as the internal group ID, the member list, and the restricted area of each group.

In operation 3, the UDM requests the UDR to update the data. A data update request may include a request for the external group ID, the internal group ID, the group MBR UL/DL, and the like. The UDM may allocate an internal group ID to be used only in a network for the external group ID received from the AF. Alternatively, when the UDM has already allocated an internal group ID previously mapped, the allocated internal group ID may be used in the network.

In operation 4, the UDM may transmit a parameter create/update/delete response to the AF or to the AF via NEF. The parameter create/update/delete response may include a DNN/S-NSSAI, an external group ID, a group MBR UL/DL, and the like.

In operation 5, the UDR may transmit a notification to the PCF to report information changed in operation Ob. The notification transmitted by the UDR to the PCF may include a DNN/S-NSSAI, an internal group ID, a group MBR UL/DL, a remaining group MBR UL/DL, and the like.

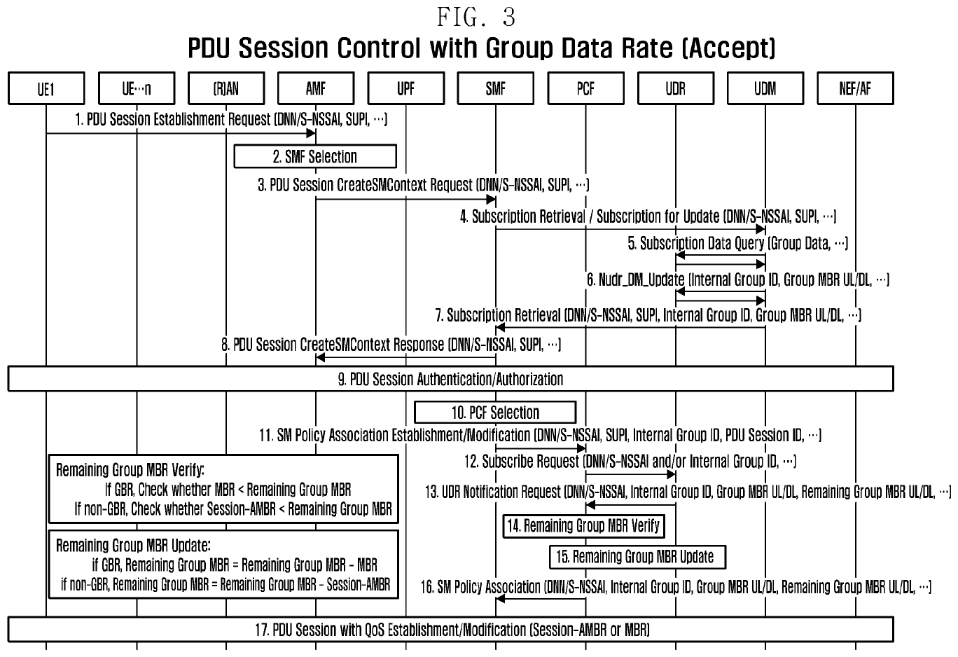

FIG. 3 illustrates an operation flow of accepting a corresponding flow by performing control for each PDU session to support a maximum data rate for each group according to an embodiment of the present disclosure.

A UDR may temporarily record and store a maximum data rate for each group to support the maximum data rate for each group, and a PCF may perform monitoring and control for each separate flow to support the maximum data rate for each group. Whenever allowing a new flow, the PCF may subtract an MBR of a GBR and an AMBR of a non-GRR, and record a remaining data rate for each group in the UDR.

In one example of A, when the remaining data rate is less than the MBR or AMBR, an additional measure may be conducted for a corresponding QoS flow as shown below:
(1) Not allowing the QoS flow;
(2) Reporting an additional data rate by reporting to a corresponding application function (AF);
(3) Reporting to a corresponding charging function (CHF) and applying a separate charging rule;
(4) Applying (1) and (2) at the same time: Not allowing the QoS flow and reporting the additional data rate by reporting to the application function (AF); and/or
(5) Applying (3) and (2) at the same time: Reporting to the corresponding charging function (CHF) and applying the separate charging rule, and reporting the additional data rate by reporting to the application function (AF).

In one example of B, the following method may be applied to identify traffic of each group:
(1) Using only a DNN and an S-NSSAI mapped to the group in combination;
(2) Using the DNN, the S-NSSAI, and an internal group ID mapped to the group in combination;
(3) Using only the internal group ID mapped to the group;
(4) Using only the internal group ID and the S-NSSAI mapped to the group in combination;
(5) Using only the internal group ID and the DNN mapped to the group in combination;

In operation 1, a UE, which is a member of a group, transmits a PDU session request to an AMF. The PDU session request may include a DNN/S-NSSAI, a SUPI, and the like. The SUPI may be included in a form of being encrypted or mapped to a temporary ID instead of being directly included. Even in this case, the AMF may finally identify the SUPI by conversion.

In operation 2, the AMF may select an SMF. The AMF may select the SMF considering an SMF that is a member of the group and supports group communication.

In operation 3, the AMF may transmit an SM context creation request for a PDU session to the SMF. The SM context creation request may include the DNN/S-NSSAI, the SUPI, and the like.

In operation 4, the SMF may transmit a subscribe message for retrieval of subscriber information and a notification in a case where the subscriber information is changed to a UDM. The subscribe message transmitted by the SMF to the UDM may include the DNN/S-NSSAI, the SUPI, and the like.

In operation 5, the UDM may inquire about and receive the subscriber information from the UDR. The information that the UDM receives from the UDR may include group data and the like. The UDM may identify and use group data to which a subscriber belongs. The group data may include attribute information, such as an internal group ID, a member list, and a restricted area of each group.

In operation 6, the UDM may receive information about a maximum data rate for each group by making a request to the UDR. The information that the UDM receives from the UDR may include the internal group ID, a group MBR UL/DL, and the like. Operation 5 and operation 6 may also be combined into one operation.

In operation 7, the UDM may transmit the subscriber information to the SMF. The transmitted subscriber information may include the DNN/S-NSSAI, the SUPI, the internal group ID, the group MBR UL/DL, and the like. The subscriber information may include an indication indicating whether a group MBR is supported instead of the group MBR UL/DL.

In operation 8, the SMF may transmit an SM context creation response for the PDU session to the AMF. The SM context creation response may include the DNN/S-NSSAI, the SUPI, and the like.

In operation 9, a procedure of authenticating the UE and a procedure of authorizing the PDU session may be performed.

In operation 10, the SMF may select a PCF. The SMF may identify whether the group is supported and the maximum data rate for each group is supported in the subscriber information identify in operation 7, and may select the PCF considering whether this function is supported.

In operation 11, the SMF transmits an SM policy association request to the PCF. The SM policy association request may include the DNN/S-NSSAI, the SUPI, the internal group ID, a PDU session ID, and the like.

In operation 12, the PCF transmits a subscribe request to the UDR to request a notification when a condition is changed. The subscribe request may include the DNN/S-NSSAI and/or the internal group ID. In this process, in addition to (1) of B described above, criteria of (2), (3), (4), and (5) may be used.

In operation 13, the UDR may transmit a notification of related information to the PCF. The notification of the related information may include the DNN/S-NSSAI, the internal group ID, the group MBR UL/DL, a remaining group MBR UL/DL, and the like. In this process, in addition to (1) of B described above, criteria of (2), (3), (4), and (5) may be used.

In operation 14, the PCF identifies the remaining group MBR. That is, when the flow is a GBR, the PCF identifies whether MBR<remaining group MBR. When the flow is a non-GBR, the PCF identifies whether Session-AMBR<remaining group MBR.

In operation 15, the PCF updates the remaining group MBR and then reflects this value in the UDR. That is, when yes is identified in a process of verifying the remaining group MBR in operation 14, if the flow is the GBR, a value of the existing remaining group MBR minus the MBR is a new remaining group MBR. When yes is identified in the process of verifying the remaining group MBR in operation 14, if the flow is the non-GBR, a value of the existing remaining group MBR minus a session-AMBR is a new remaining group MBR.

In operation 16, the PCF transmits an SM policy association response to the SMF. The SM policy association response may include the DNN/S-NSSAI, the internal group ID, the group MBR UL/DL, the remaining group MBR UL/DL, and the like.

In operation 17, when the flow is the GBR, the SMF performs a QoS establishment procedure that guarantees the GBR by exchanging additional signals with an RAN, the UE, and a UPF. The result may be finally reported to the AF. When the flow is the non-GBR, the SMF performs a QoS establishment procedure that guarantees the session-AMBR by exchanging additional signals with the RAN, the UE, and the UPF. The result may be finally reported to the AF.

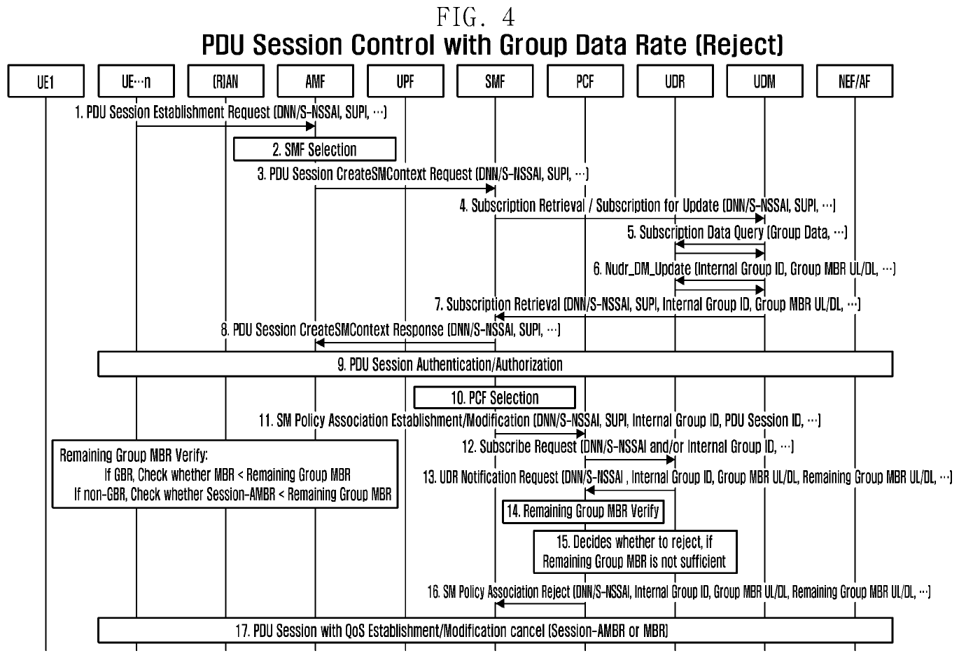

FIG. 4 illustrates an operation flow of rejecting a corresponding flow by performing control for each PDU session to support a maximum data rate for each group according to an embodiment of the present disclosure.

A UDR may temporarily record and store a maximum data rate for each group to support the maximum data rate for each group, and a PCF may perform monitoring and control for each separate flow to support the maximum data rate for each group. Whenever allowing a new flow, the PCF may subtract an MBR of a GBR and an AMBR of a non-GRR, and record a remaining data rate for each group in the UDR.

In one example of A-1, when the remaining data rate is less than the MBR or AMBR, an additional measure may be conducted for a corresponding QoS flow as shown below:
(1) Not allowing the QoS flow;
(2) Reporting an additional data rate by reporting to a corresponding application function (AF);
(3) Reporting to a corresponding charging function (CHF) and applying a separate charging rule;
(4) Applying (1) and (2) at the same time: Not allowing the QoS flow and reporting the additional data rate by reporting to the application function (AF); and/or
(5) Applying (3) and (2) at the same time: Reporting to the corresponding charging function (CHF) and applying the separate charging rule, and reporting the additional data rate by reporting to the application function (AF).

In one example of B-1, the following method may be applied to identify traffic of each group.
(1) Using only a DNN and an S-NSSAI mapped to the group in combination;
(2) Using the DNN, the S-NSSAI, and an internal group ID mapped to the group in combination;
(3) Using only the internal group ID mapped to the group;
(4) Using only the internal group ID and the S-NSSAI mapped to the group in combination; and/or
(5) Using only the internal group ID and the DNN mapped to the group in combination.

In operation 1, a UE, which is a member of a group, transmits a PDU session request to an AMF. The PDU session request may include a DNN/S-NSSAI, a SUPI, and the like. The SUPI may be included in a form of being encrypted or mapped to a temporary ID instead of being directly included. Even in this case, the AMF may finally identify the SUPI by conversion.

In operation 2, the AMF may select an SMF. The AMF may select the SMF considering an SMF that is a member of the group and supports group communication.

In operation 3, the AMF may transmit an SM context creation request for a PDU session to the SMF. The SM context creation request may include the DNN/S-NSSAI, the SUPI, and the like.

In operation 4, the SMF may transmit a subscribe message for retrieval of subscriber information and a notification in a case where the subscriber information is changed to a UDM. The subscribe message transmitted by the SMF to the UDM may include the DNN/S-NSSAI, the SUPI, and the like.

In operation 5, the UDM may inquire about and receive the subscriber information from the UDR. The information that the UDM receives from the UDR may include group data and the like. The UDM may identify and use group data to which a subscriber belongs. The group data may include attribute information, such as an internal group ID, a member list, and a restricted area of each group.

In operation 6, the UDM may receive information about a maximum data rate for each group by making a request to the UDR. The information that the UDM receives from the UDR may include the internal group ID, a group MBR UL/DL, and the like. Operation 5 and operation 6 may also be combined into one operation.

In operation 7, the UDM may transmit the subscriber information to the SMF. The transmitted subscriber information may include the DNN/S-NSSAI, the SUPI, the internal group ID, the group MBR UL/DL, and the like. The subscriber information may include an indication indicating whether a group MBR is supported instead of the group MBR UL/DL.

In operation 8, the SMF may transmit an SM context creation response for the PDU session to the AMF. The SM context creation response may include the DNN/S-NSSAI, the SUPI, and the like.

In operation 9, a procedure of authenticating the UE and a procedure of authorizing the PDU session may be performed.

In operation 10, the SMF may select a PCF. The SMF may identify whether the group is supported and the maximum data rate for each group is supported in the subscriber information identify in operation 7, and may select the PCF considering whether this function is supported.

In operation 11, the SMF transmits an SM policy association request to the PCF. The SM policy association request may include the DNN/S-NSSAI, the SUPI, the internal group ID, a PDU session ID, and the like.

In operation 12, the PCF transmits a subscribe request to the UDR to request a notification when a condition is changed. The subscribe request may include the DNN/S-NSSAI and/or the internal group ID. In this process, in addition to (1) of B-1 described above, criteria of (2), (3), (4), and (5) may be used.

In operation 13, the UDR may transmit a notification of related information to the PCF. The notification of the related information may include the DNN/S-NSSAI, the internal group ID, the group MBR UL/DL, a remaining group MBR UL/DL, and the like. In this process, in addition to (1) of B-1 described above, criteria of (2), (3), (4), and (5) may be used.

In operation 14, the PCF identifies the remaining group MBR. That is, when the flow is a GBR, the PCF identifies whether MBR<remaining group MBR. When the flow is a non-GBR, the PCF identifies whether Session-AMBR<remaining group MBR.

In operation 15, the PCF may determine whether to reject the flow when no is identified in a process of verifying the remaining group MBR in operation 14. That is, when the flow is the GBR in operation 14 and the existing remaining group MBR is less than the MBR, the PCF may cancel QoS guarantee of the flow. When the flow is the non-GBR in operation 14 and the remaining group MBR is less than the session-AMBR, the PCF may cancel QoS guarantee of the flow. In operation 15, in addition to (1) described above in A-1, (2), (3), (4), and (5) may be selected.

In operation 16, the PCF transmits an SM policy association response to the SMF. The SM policy association response may include the DNN/S-NSSAI, the internal group ID, the group MBR UL/DL, the remaining group MBR UL/DL, and the like.

In operation 17, when the flow is the GBR, the SMF performs a QoS establishment procedure that guarantees the GBR by exchanging additional signals with an RAN, the UE, and a UPF. The result may be finally reported to the AF. When the flow is the non-GBR, the SMF performs a QoS establishment procedure that guarantees the session-AMBR by exchanging additional signals with the RAN, the UE, and the UPF. The result may be finally reported to the AF.

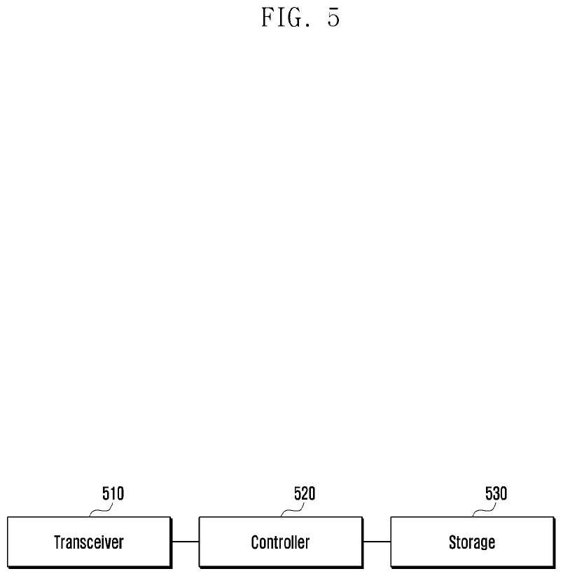

FIG. 5 illustrates a terminal according to an embodiment of the disclosure according to an embodiment of the present disclosure.

Referring to FIG. 5, the terminal may include a transceiver 510, a controller 520, and a storage 530. In the disclosure, the controller may be defined as a circuit, an application-specific integrated circuit, or at least one processor.

The transceiver 510 may transmit and receive a signal to and from another network entity. For example, the transceiver 510 may receive system information from a base station, and may receive a synchronization signal or a reference signal.

The controller 520 may control the overall operation of the terminal according to an embodiment provided in the disclosure. For example, the controller 520 may control the overall function of the terminal according to an embodiment provided in the disclosure. For example, the controller 520 may control the terminal or UE to generate a request for a PDU session and transmit the same to an AMF.

The storage 530 may store at least one of information transmitted and received through the transceiver 510 and information generated through the controller 520. For example, the storage 530 may store information related to a PDU session, information related to authentication of a PDU session, or the like.

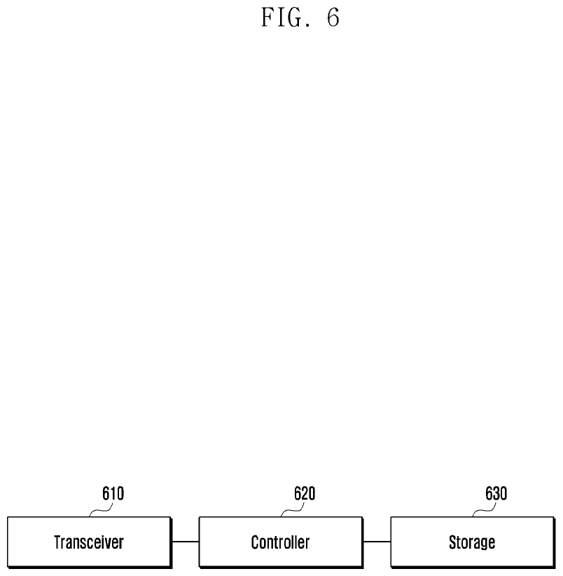

FIG. 6 illustrates a network entity according to an embodiment of the disclosure. The network entity may include an AMF, a UPF, an SMF, a PCF, a UDR, a UDM, an NEF, or an AF.

The transceiver 610 may transmit and receive a signal to and from another network entity. For example, the transceiver 610 may transmit PDU session-related information to a terminal.

The controller 620 may control the overall operation of network entities according to an embodiment provided in the disclosure. For example, the controller 620 may operate to control the operations according to the foregoing flowcharts. For example, the controller 620 may control the PCF to verify a remaining group and update an MBR for the remaining group.

The storage 630 may store at least one of information transmitted and received through the transceiver 610 and information generated through the controller 620. For example, the storage 630 may store information related to a PDU session and information about a group MBR and a remaining group MBR.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Furthermore, a plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port. Furthermore, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a policy and control function (PCF) in a wireless communications system, the method comprising:
receiving, from a session management function (SMF), a session management (SM) policy association request message for establishing a packet data unit (PDU) session, wherein the SM policy association request message includes a data network name (DNN) and single network slice selection assistance information (S-NSSAI) for a user equipment (UE) group;
transmitting, to a united data repository (UDR), a subscribe request message for a group maximum bit rate (MBR) for the UE group;
receiving, from the UDR, a notification message including a remaining group MBR for the UE group;
determining whether the remaining group MBR is higher than an MBR of the PDU session in case that the PDU session is associated with a guaranteed bit rate (GBR);
determining whether the remaining group MBR is higher than an authorized sessions aggregated maximum bit rate (AMBR) of the PDU session in case that the PDU session is not associated with the GBR;
updating the remaining group MBR based on a determination that at least one of whether the remaining group MBR is higher than the MBR or whether the remaining group MBR is higher than the authorized sessions AMBR; and
transmitting, to the UDR, an update message including the updated remaining group MBR.

2. The method of claim 1, wherein updating the remaining group MBR comprises:
deducting a value of the MBR from the remaining group MBR in case that the remaining group MBR is higher than the MBR of the PDU session and the PDU sessions is associated with the GBR; or
deducting a value of the AMBR from the remaining group MBR in case that the remaining group MBR is higher than the AMBR of the PDU session and the PDU session is not associated with the GBR.

3. The method of claim 1, further comprising:
transmitting, to the SMF, an SM policy association response message including the updated remaining group MBR in case that the remaining group MBR is higher than the MBR or the AMBR of the PDU session.

4. The method of claim 1, further comprising:
transmitting, to the SMF, an SM policy association response message indicating a rejection of a PDU session establishment in case that the remaining group MBR is lower than the MBR or the AMBR of the PDU session.

5. The method of claim 1, wherein the remaining group MBR is configured for an uplink and a downlink, respectively.

6. A method performed by a united data management (UDM) in a wireless communication system, the method comprising:
receiving, from an application function (AF), a parameter update request message including a group maximum bit rate (MBR) for a user equipment (UE) group;
transmitting, to a united data repository (UDR), a request message for group data of the UE group;
receiving, from the UDR, the group data of the UE group including an updated group MBR; and
transmitting, to the AF, a parameter update response message including the updated group MBR.

7. The method of claim 6, further comprising:
configuring the group MBR before receiving the parameter update request message from the AF.

8. The method of claim 6, wherein the remaining group MBR is configured for an uplink and a downlink, respectively.

9. A policy and control function (PCF) in a wireless communications system, the PCF comprising:
a transceiver; and
at least one processor operably coupled to the transceiver, the at least one processor configured to:
receive, from a session management function (SMF), a session management (SM) policy association request message for establishing a packet data unit (PDU) session, wherein the SM policy association request message includes a data network name (DNN) and single network slice selection assistance information (S-NSSAI) for a user equipment (UE) group,
transmit, to a united data repository (UDR), a subscribe request message for a group maximum bit rate (MBR) for the UE group,
receive, from the UDR, a notification message including a remaining group MBR for the UE group,
determine whether the remaining group MBR is higher than an MBR of the PDU session in case that the PDU session is associated with a guaranteed bit rate (GBR),
determine whether the remaining group MBR is higher than an authorized sessions aggregated maximum bit rate (AMBR) of the PDU session in case that the PDU session is not associated with the GBR,
updating the remaining group MBR based on a determination that at least one of whether the remaining group MBR is higher than the MBR or whether the remaining group MBR is higher than the authorized sessions AMBR, and
transmit, to the UDR, an update message including the updated remaining group MBR.

10. The PCF of claim 9, wherein the at least one processor is further configured to:
deduct a value of the MBR from the remaining group MBR in case that the remaining group MBR is higher than the MBR of the PDU session and the PDU sessions is associated with the GBR, or
deduct a value of the AMBR from the remaining group MBR in case that the remaining group MBR is higher than the AMBR of the PDU session and the PDU session is not associated with the GBR.

11. The PCF of claim 9, wherein the at least one processor is further configured to:
transmit, to the SMF, an SM policy association response message including the updated remaining group MBR, in case that the remaining group MBR is higher than the MBR or the AMBR of the PDU session.

12. The PCF of claim 9, wherein the at least one processor is further configured to:
transmit, to the SMF, an SM policy association response message indicating a rejection of a PDU session establishment in case that the remaining group MBR is lower than the MBR or the AMBR of the PDU session.

13. The PCF of claim 9, wherein the remaining group MBR is configured for an uplink and a downlink, respectively.

14. A united data management (UDM) in a wireless communication system, the UDM comprising:
a transceiver; and
at least one processor operably coupled to the transceiver, the at least one processor configured to:
receive, from an application function (AF), a parameter update request message including a group maximum bit rate (MBR) for a user equipment (UE) group,
transmit, to a united data repository (UDR), a request message for group data of the UE group,
receive, from the UDR, the group data of the UE group including an updated group MBR, and
transmit, to the AF, a parameter update response message including the updated group MBR.

15. The UDM of claim 14, wherein the at least one processor is further configured to:
configure the group MBR before receiving the parameter update request message from the AF.

16. The UDM of claim 14, wherein the remaining group MBR is configured for an uplink and a downlink respectively.
